(19) United States
(12) Patent Application Publication
(10) Pub. No.: US 2011/0095601 A1
(43) Pub. Date: Apr. 28, 2011

(54) Switch module for a power supply network and power supply network comprising at least one switch module

(75) Inventor: Eilert Johansson, Molnycke (SE)

(73) Assignee: VOLVO TECHNOLOGY CORPORATION, Goteborg (SE)

(21) Appl. No.: 12/988,645

(22) PCT Filed: May 26, 2009
(86) PCT No.: PCT/SE2009/000268

§ 371 Date: Oct. 20, 2010

(30) Foreign Application Priority Data
May 26, 2008 (SE) PCT/SE2008/000354

(51) Int. Cl. B60L 1/00; H02J 4/00

(52) U.S. Cl. 307/9.1; 307/18

(57) ABSTRACT

A switch module includes at least one switch exhibiting at least two states of operation, provided for connecting at least two conductor segments of an electrical power supply network, the electrical power supply network including one or more power sources and one or more electrical loads. One control unit is provided per switch and is operatively coupled to the switch for controlling the states of operation of the switch. Each control unit includes a selection unit for selecting a state of operation of the switch coupled to the respective control unit. A method for operating such switch modules and an electric power supply network are also provided.

### BACKGROUND AND SUMMARY

The invention relates to a switch module for a power supply network and a power supply network comprising at least one switch module.

Particularly in vehicles of future technologies redundancy of the electrical power supply is required in several subsystems. Obvious applications are safety critical systems like brakes, steering, etc. There are also other systems which influence the real time behaviour of the vehicle such as chassis control and the like, powertrain components such as valves etc., electrically controlled gearboxes and the like. Some of today's mechanical components may completely rely on electronic control. An electrical failure can lead to a mechanical breakdown.

It is known in the art that a typical automotive electrical power supply network is provided with a star configuration or a daisy-chain configuration. A short circuit in any point of such configurations shuts down the complete network downstream the nearest fuse to the short circuit.

It is also known to provide electrical power supply networks featuring a ring configuration. For providing redundancy several solutions are known in the art. There are completely separated redundant systems with different communication, power supply, sensors and actuators. The redundant systems meet in a mechanical domain or in some cases in a magnetically domain in an electrical actuator with multiple windings. Although the redundancy can be easily analysed the solution is very expensive for volume production, e.g. in vehicle manufacturing.

A simple solution for each unit in the power supply network is provided by using local energy backup. However, the energy resources are limited, it is expensive to build supervision of energy storage in each node and the management of selected energy sources is necessary.

Another solution is to use dual supply to each node (dual star network supply). Thus, two independent supply networks are available. However, dual harness and management of selected energy sources is necessary.

The U.S. Pat. No. 6,552,442 B1 discloses a power supply network with a ring configuration. For each load a tap controller is provided which is composed of an intelligent control node and two controllable power dividers and a controllable conductor protector such as a circuit breaker. The control node controls both power dividers and the conductor protector. For proper functioning of the two controllable power dividers a communication with the intelligent control node is a necessary condition.

EP 1759929 A1 discloses a power supply system for a vehicle, wherein each load is connected to an electrical power supply network. The loads are connected to the power feed via a switch which is controlled by a control unit. Each switch is connected to a communication bus. The switch disconnects the load from the power feed in case of an abnormal current.

It is desirable to provide an improved electrical power supply network which is redundant if a switch fails. It is also desirable to provide an improved switch module for an electrical power supply network. It is also desirable to provide a method for operating the switch module.

A switch module provided for connecting at least two conductor segments of an electrical power supply network is proposed, the electrical power supply network comprising one or more power sources and one or more electrical loads. A switch is provided with a dedicated control unit for controlling the switch. By providing the switch with a dedicated control unit for this particular switch, an autonomous operation of the switch can be achieved as well as a redundant operation of the respective electrical power supply switch. By way of example, in a typical ring configuration of an electrical power supply network known in the art two switches are provided with one common control module for the two switches. If the controller breaks, the load inevitably looses power. By preferably providing two preferred autonomous switch modules according to the invention for one load redundancy of supplying power to the load is possible even if one of the controllers fails. A communication between individual switch modules within a plurality of switch modules is not mandatory as the switch units operate autonomously. The load can be an electric device, an electric motor or the like. The switch itself can be a relay, a semiconductor switch built with bipolar or MOSFET transistors or what is appropriate as switch in a particular switch module for a desired electrical power supply network.

Each control unit comprises a selection unit for selecting a state of operation of the switch coupled to the respective control unit. The selection unit can be implemented as software or hardware or a combination of software and hardware. Particularly, the control unit can comprise a current and a voltage supervision and a state machine. A state machine can be best understood as a model of behaviour composed of a finite number of states, transitions between those states and actions.

Other than the prior art, the switch can operate autonomously and hence does not need a connection to a communication bus for being operative. Thus, the control unit can decide autonomously which operation state of the switch, e.g. an “on” operation state with the switch closed or an “off operation state with the switch open has to be applied. Due to the autonomous operation the switch module, by way of example in an electrical power supply network, does not rely on communication to other switch modules (nodes) or a main computer, particularly not for a real time behaviour of the switch module. The decisions on the state of operation of the switch can be taken by the particular state machine of the switch. In certain cases, however, communication can be advantageously used for setting parameters and supervision of the switch modules. Advantageously, the switch module can comprise at least one communication unit for communicating at least with one or more switch modules and/or a power management system. For instance, a feed back about a power failure and a probable location of the failure can be given to such a power management system. Preferably this at least one communication unit can be integrated in the control unit. The communication unit can be coupled to a data bus system or the like.

Optionally it is possible that each switch module comprises an “intelligent” local power management system instead of a central power management system. These local power management systems can form a grid of intelligent computers which dynamically collaborate in managing the power distribution etc. of the whole system (“distributed intelligence”). The system can be autarkic without any central station. By employing such a distributed system redundancy and safety of the system can be improved further.

Preferably, the state of operation of the switch is selectable depending on one or more operating parameters of the electrical power supply network.

The autonomous switch module enables to build a simple and low cost redundant power supply system. Circular power supply systems yield redundancy without having a double power supply system. The autonomous switch makes the selection process of power supply line robust and easy to analyse, which is important for critical systems.

The state machine can be implemented in several different ways, e.g. in software or in hardware or in a combination of both. A very simple implementation for instance, which is particularly useful for a dual star network, is to have two diodes (one for each supply-line), in combination with one or more fuses or other current limiting devices.

According to an advantageous development of the invention, the switch module can comprise at least one programmable unit for setting operating parameters of each switch. Preferably this at least one programmable unit can be integrated in the control unit.

Preferably, a current sensor and/or a voltage sensor can be coupled to each switch. The current can be detected on either side of the switch. The voltage is advantageously detected on both side of the switch. A minimum voltage can be set for each switch. A high degree of safety can be achieved if two voltage sensors are provided, one at each side of the switch, additionally to a current sensor. If the safety requirements are lower, a less number of sensors can be used. If the detected voltage is above the minimum voltage, the power supply network is considered as working properly, if the detected voltage is below the minimum voltage, a failure is recognized by the control unit and the state of operation of the switch is set accordingly. In this case, the voltage limit is set to a value that if the actual voltage is equal to or below this limit, the voltage is considered to be too low. Alternatively, it is possible to set a voltage limit in a way that in case the actual voltage is above or equal to the limit the power supply network is considered as working properly and if the actual voltage is below the voltage limit, a failure is recognized.

Proposed is also a method for operating a switch module connecting at least two conductor segments of an electrical power supply network, the electrical power supply network being powered by one or more power sources and supplying one or more electrical loads. A state of operation of a switch is controlled by a dedicated control unit provided for the switch.

Preferably, the state of operation of the switch can be selected depending on operating parameters of the switch and/or operating parameters of the electrical power supply network. Particularly, the switch can be operated depending on an electrical current through the switch and an electrical voltage on both sides of the switch.

According to another aspect of the invention, an electrical power supply network is proposed, comprising one or more power sources and one or more electrical loads and comprising at least one switch module which is provided for electrically connecting and disconnecting at least two conductor segments.

The electrical power supply network can be arranged in a star configuration of power distribution, in a double star configuration of power distribution, in a ring configuration of power distribution, or in a combination of two or more of the said configurations of power distribution.

Preferably, a first and a second autonomous switch module can be provided for each load particularly in the ring configuration of power distribution.

According to a preferred embodiment, the switch module can be arranged outside an electric load which is coupled to the electrical circuit.

According to another preferred embodiment, the switch module can be integrated into an electric load. It is also possible to combine these two embodiments, wherein at least one load in the electrical power supply network comprising at least one autonomous switch module is provided with an integrated autonomous switch module.

According to another aspect of the invention, a vehicle comprises an electrical power supply network which comprises at least one autonomous switch module. The vehicle can for instance be an electric vehicle or a hybrid vehicle comprising e.g. an electric motor and a combustion engine which both provide energy for propulsion of the vehicle. The preferred autonomous switch module is particularly useful for providing a redundant automotive power supply. Expediently, the particular vehicle can feature a ring configuration of power distribution. Favourably, a power supply redundancy can be achieved particularly for control units, actuators and/or sensors. Many vehicular systems which are used for supporting the driver or which are used for increasing the vehicle safety and the driving comfort rely on such electrical components.

The vehicle can be a landborne vehicle or a seaborne vehicle, such as a ship or submarine, or an airborne vehicle, such as an airplane or a space vehicle. The term “landborne vehicle” comprises for instance passenger cars, busses, trucks, motorbikes, trains, construction equipment and the like, particularly wheeled and crawler excavators (diggers), articulated haulers (such as dumpers, dump trucks), scraper haulers, wheel loaders, pipelayers, demolition equipment, waste handlers, motor graders, pavers, compactors, milling equipment, tack distributors, road wideners, material-transfer vehicles and a range of compact equipment such as mini loaders, mini excavators, backhoe loaders and skidsteer loaders.

According to another aspect of the invention, a working machine comprises an electrical power supply network which comprises at least one autonomous switch module. The working machine can for instance be a stationary electric working machine or a stationary hybrid working machine comprising e.g. an electric motor and a combustion engine which both provide energy for moving one or more tools of the working machine. The preferred autonomous switch module is particularly useful for providing a redundant power supply. Expediently, the particular working machine can feature a ring configuration of power distribution. Favourably, a power supply redundancy can be achieved particularly for control units, actuators and/or sensors. Many working machine systems which are used for supporting the operator or which are used for increasing the working machine safety and the operating comfort rely on such electrical components.

According to another aspect of the invention, an energy supply facility comprises an electrical power supply network which comprises at least one autonomous switch module. The energy supply facility can for instance be a stationary energy supply facility or a mobile energy supply facility which provides energy for a multitude of users such as households or industrial plants. The preferred autonomous switch module is particularly useful for providing a redundant power supply. Expediently, the particular energy supply facility can feature a ring configuration of power distribution. Favourably, a power supply redundancy can be achieved. Particularly, the energy supply facility can be an emergency backup generator.

### BRIEF DESCRIPTION OF THE DRAWINGS

The present invention together with the above-mentioned and other objects and advantages may best be understood from the following detailed description of the embodiments, but not restricted to the embodiments, wherein is shown schematically:

FIG. 1 a preferred embodiment of a switch module according to the invention;

FIG. 2 a preferred electrical power supply network according to the invention featuring a ring configuration;

FIG. 3 a load with an integrated autonomous switch module according to the invention;

FIG. 4 an example of a state machine coupled to the switch according to FIG. 1;

FIG. 5 an example of a preferred electrical power supply network according to the invention featuring a ring contiguration comprising a fault;

FIG. 6a-6e simulation results for voltage characteristics of the loads implemented in the electrical power supply network of FIG. 5.

### DETAILED DESCRIPTION

In the drawings, equal or similar elements are referred to by equal reference numerals. The drawings are merely schematic representations, not intended to portray specific parameters of the invention. Moreover, the drawings are intended to depict only typical embodiments of the invention and therefore should not be considered as limiting the scope of the invention.

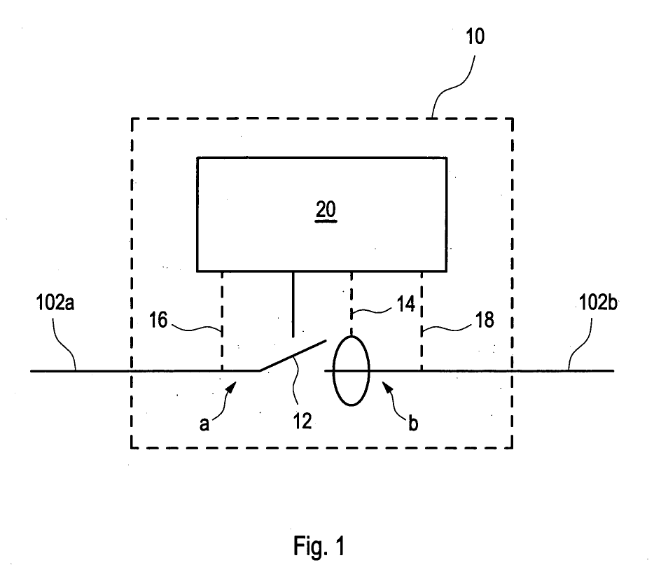

FIG. 1 depicts schematically a preferred embodiment of a switch module 10 according to the invention. The switch module 10 connects at least two conductor segments 102a, 102b of an electrical power supply network (not shown), which comprises one or more power sources (not shown) and one or more electrical loads (not shown).

The switch module 10 comprises a switch 12 and a control unit 20 for controlling the switch 12. A current sensor 14 on one of the two sides of the switch 12, a first voltage sensor 16 on one side of the switch 12 (hereinafter called the “a” side) and another voltage sensor 18 on the other side of the switch 12 (hereinafter called the “b” side) are arranged for sensing the electrical current through the switch 12 and the voltage on each side the of the switch 12.

The switch module 10 is implemented as an autonomous component and can be implemented with or without communication to other switch modules (not shown) and/or power management systems (not shown). The autonomous switch module 10 is controlled by a state machine with preset limits, e.g. a current limit and/or a voltage limit, and timings for the performance of the switch module 10.

For diagnostic purposes and adaptation to varying conditions present in the electrical power supply network to which the switch module 10 is coupled, the autonomous switch module 10 can be connected to a supervision function, e.g. via a network and the like. For such purposes at least one communication unit (not shown) is provided in the switch module 10.

The state machine comprised in the control unit 20 operates the switch 12 based on voltage and current information collected by the current sensor 14 and the voltage sensors 16 and 18. Preferably, the control unit 20 comprises a selection unit for selecting a state of operation of the switch 12 coupled to the control unit 20.

The state of operation of the switch 12 is selected by the state machine depending on one or more operating parameters of the electrical power supply network (not shown).

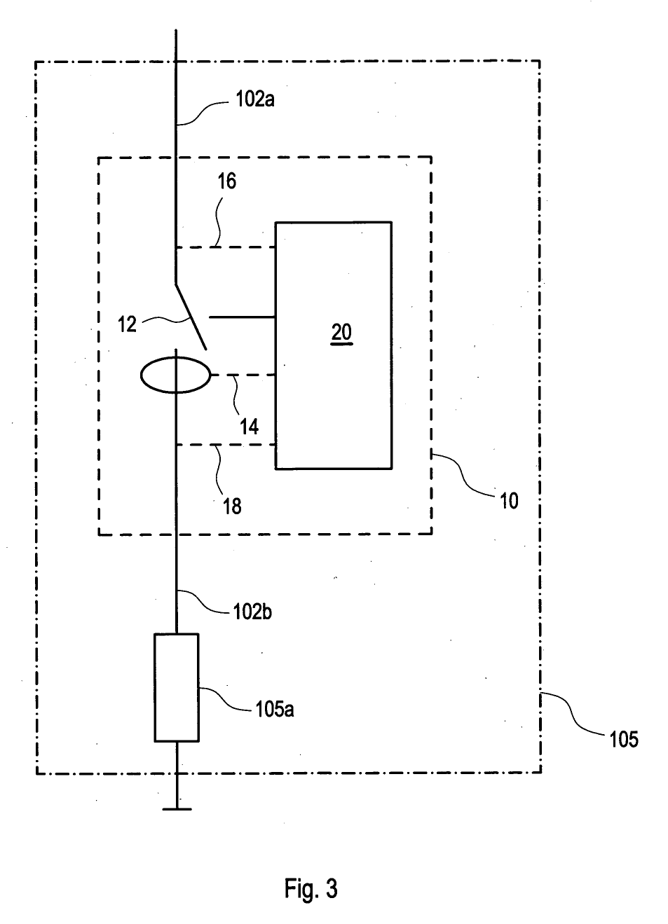

Preferably, the switch module 10 can be integrated in the network, separate from the load. However, the switch module 10 can be integrated in a load 105, as indicated in FIG. 3. The autonomous load 105 comprises the switch module 10 in series with a load element 105a integrated into a single device forming the autonomous load 105. For a description of the components of the switch module 10 reference is made to FIG. 1.

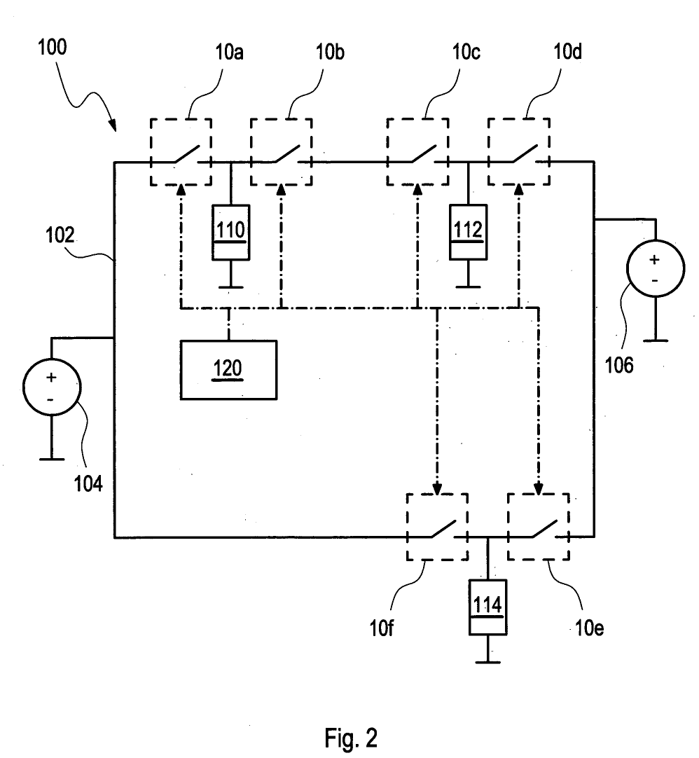

FIG. 2 depicts a preferred example of an electrical power supply network 100 featuring a ring configuration. Three electric loads 110, 112, 114 are supplied with power from two power supplies 104 and 106.

Each load 110, 112, 114 is provided with two switch modules 10a, 10b, 10c, 10d, 10e, 10f configured as described in FIG. 1, wherein the load 110 is provided with switch modules 10a, 10b, the load 112 is provided with switch modules 10c, 10d, and the load 114 is provided with switch modules 10e, 10f. A system management unit 120 can supervise the switch modules 10a . . . 10f and/or can provide communication between (i) the switch modules 10a . . . 10f and the system management unit 120 and (ii) among the switch modules 10a . . . 10f themselves. The switch modules 10a . . . 10f are depicted schematically without switches and control units for clarity reasons. Details of the switch modules 10a . . . 10f are described in FIG. 1.

As indicated in FIG. 1 , the state of operation of each of the individual switches 12 in the switch modules 10a . . . 10f is controlled by a corresponding dedicated control unit 20 provided for each of the individual switches 12.

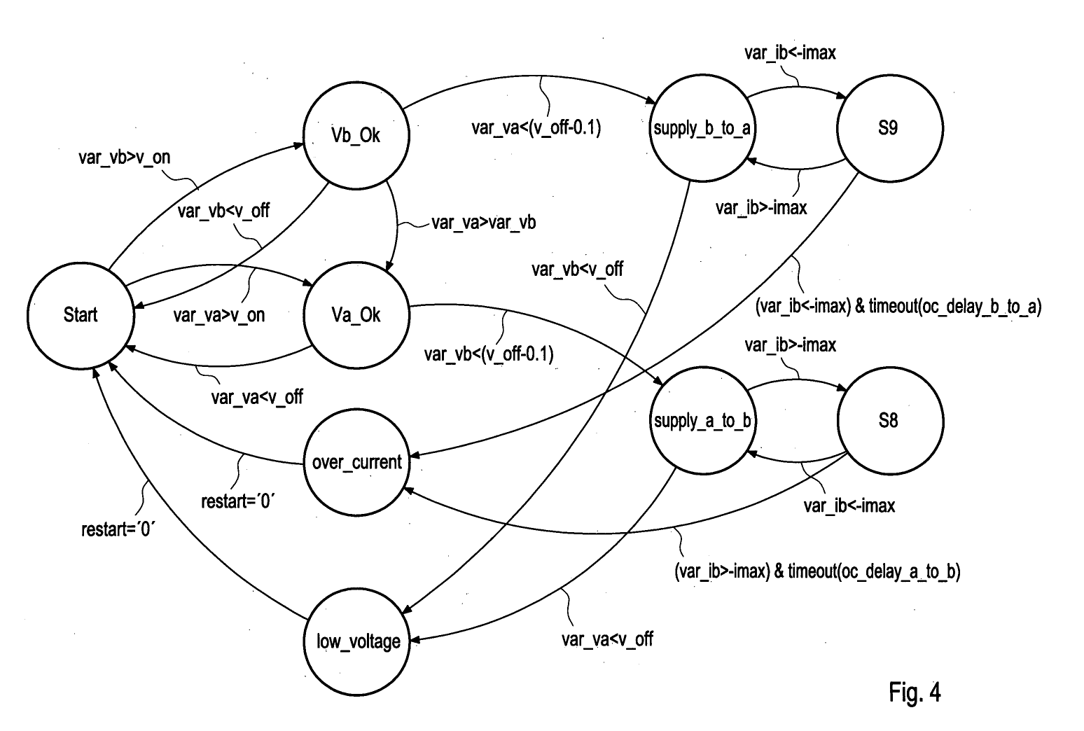

FIG. 4 depicts how a preferred state machine works. The state machine has a number of states. In each state there is a variable defining if the switch is open or closed. Depending on voltage on the first side (the “a” side) and on the other side (the “b” side) of the switch (e.g. sensed by voltage sensors 16, 18 in FIG. 1), measured current through the switch (e.g. sensed by current sensor 14 in FIG. 1) and parameter settings the state machine will move between different states and then taking actions by opening and closing the switch.

The circles labelled with parameters “Start”, “Va_Ok”, “VbJDk”, “over_current”, “low_voltage”, “supply_b_to_a”, “supply_a_to_b”, “S8”, “S9” represent states of the state machine, whereas the lines with arrows connecting the circles indicate transitions from one state to another, wherein the arrows indicate the direction from which state to which state the transition occurs. Each transition arrow is referred to with a transition condition such as the transition “var_vb>v_on” between a state represented by circle “Start” and another state represented by circle “vb_Ok”.

The following transitions and states are depicted in FIG. 4.

1. Transitions:
var_vb, which is the voltage at 102b;
var_va, which is the voltage at 102a;
v_on, which is the lowest voltage when the switch is turned on;
v_off, which is the highest voltage when the switch is turned off;
var_ib, which is the current measured by sensor 14;
imax, which is the highest continuous current allowed to flow through the switch unit 10;
oc_delay_b_to_a, which is the time from detection of a too high current until the switch is opened when the switch is supplying a current from 102b to 102a;
oc_delay_a_to_b, which is the time from detection of a too high current until the switch is opened when the switch is supplying a current from 102a to 102b;
restart, which is an external signal allowing the state machine to restart after a fault.

2. States:
Start, which is the initial state;
vb_OK, which is reached from the start state when var_vb>v_on saying that the voltage at 102b is OK;
va_OK, which is which is reached from start state when var_va>v_on saying that the voltage at 102a is OK;
over_current, which is reached when an over current has occurred and been valid for a defined time (oc_delay_b_to_a or oc_delay_a_to_b);
low_voltage, which is reached when the supplying voltage is below the defined level v_off;
supply_b_to_a, which is reached from the state Vb_OK when Va is below the supply voltage v_off and an extra margin at e.g. 0.1V (the value depends in tolerances, noise etc. in the system);
supply_a_to_b, which is reached from the state Va_OK when Vb is below the supply voltage v_off and an extra margin at e.g. 0.1V (the value depends in tolerances, noise etc. in the system);
S9, which is a hold state when a high current situation has occurred, waiting for the oc_delay_b_to_a time to be reached;
S8, which is a hold state when a high current situation has occurred, waiting for the oc_delay_a_to_b time to be reached.

The example in FIG. 4 provides protection against an overcurrent situation and selects a supply voltage which is above a minimum level. It is possible (but not shown) to extend the protection for instance against an overvoltage, a reverse current, an overtemperature in the switch modules and the like.

Referring now back to the example embodiment in FIG. 2 in combination with FIG. 1, wherein the switch modules 10a and 10b are assigned to the load 110, the state machines in the switch modules 10a, 10b decide on the states of operation of the switches in switch modules 10a, 10b. This means for instance that if the voltage “var_va” sensed by the voltage sensors assigned to the switch of e.g. the switch module 10a is above a voltage “v_on”, then the state of operation of the switch of the switch module 10a is “no fault” (“va_OK”). When starting up the power supply network 100, that switch that first can supply a voltage will be considered as the one supplying said voltage. There is advantageously also a parameter for a delay setting which controls how fast a switch closes for supplying current from one side to the other, e.g. from “a” to “b”, and another parameter setting how fast the same switch closes for supplying current from “b” to “a”. The switch is only closed if the voltage on one side is above the voltage level “v_on” and the voltage on the other side is below the voltage level “v_off-0.1” whereby the value 0.1 (i.e. 0.1 Volt) is an example only and the actual value depends in tolerances, noise etc. in the system). The preferred delays are important to avoid time race in the circuit and avoid unstable conditions.

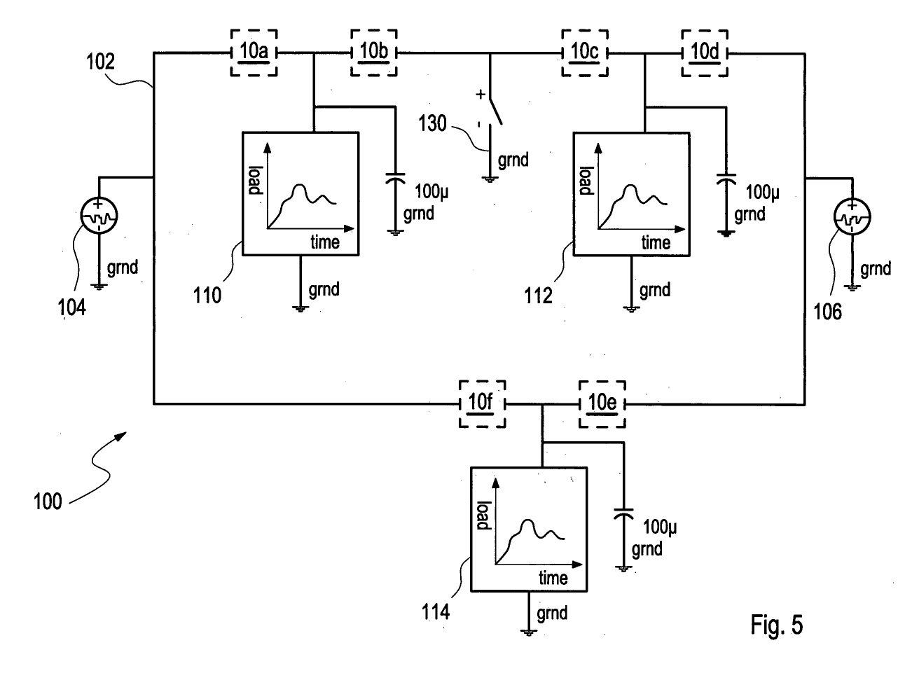

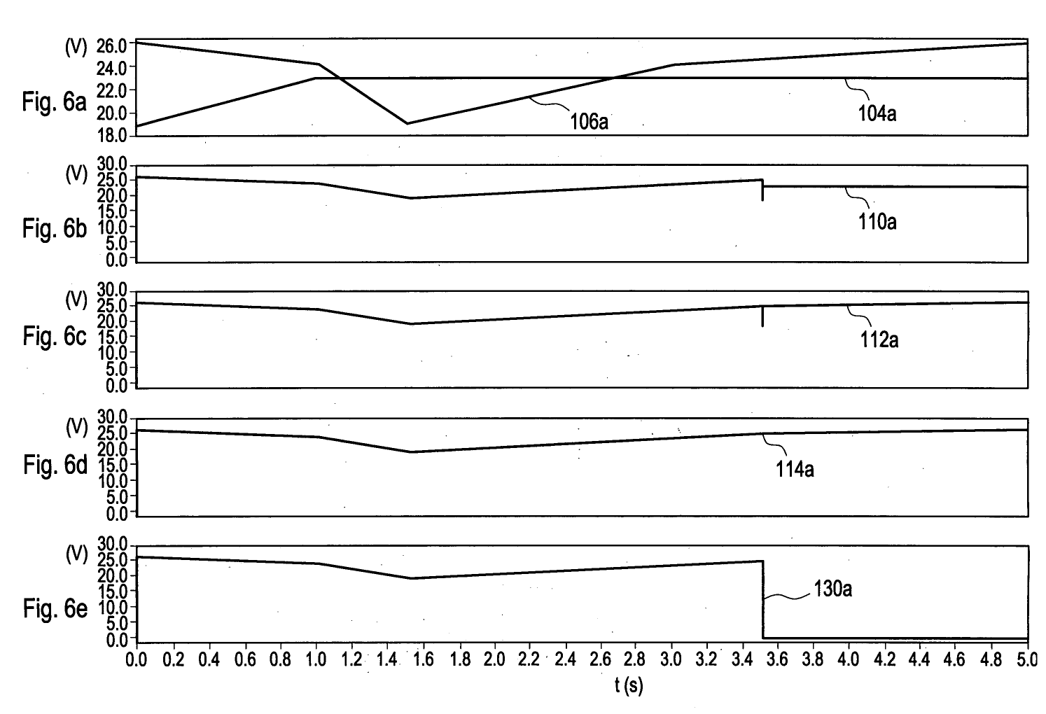

FIG. 5 in combination with FIG. 6 illustrates a simulation of an electric power supply network 100 as described in FIG. 2. FIG. 5 is a simulation model of the electric power supply network 100 depicted in FIG. 2. Therefore, with respect to the detailed description of FIG. 5 reference is made to the description of FIG. 2. Results of a simulation of voltage characteristics over a time period of δt=5 seconds are shown in FIGS. 6a-6e. The voltage traces display the redundancy of the electric power supply network according to the invention. The loads 110, 112, 114 are represented in the simulation by time dependent graphs with electrically parallel capacitances of 100 μF.

At a time t=0 the electric power supply network 100 operates correctly without any fault. The autonomous switch modules 10a, 10b . . . 10e, 10f select the power supply 104, 106 as voltage source providing the highest voltage individually for each load 110, 112, 114. At a time t=3.5 s thereafter a short circuit occurs. The short circuit is represented by switch element 130, which can be simulated by closing the switch 130 for a certain time period, for instance δt=0.5 seconds.

The circuit is a simulation of a small system with two power supplies and three loads. At a time t=0 s there are no faults in the system. The autonomous switch modules 10a . . . 10f select the voltage source 104 or 106 with the highest voltage individually for each load 110, 112, 114. At time t=0, only the output voltage 106a of voltage source 106 is above the minimum level set by parameters as can be seen in FIG. 6a. This is the reason for why all of the loads 110, 112, 114 are powered by the voltage source 106 at start up. “v_on” is set to e.g. 20V and “v_off” is set to e.g. 18V. At the time t=3.5 seconds, a short circuit occurs simulated by closing the switch 130 to ground for δt=0.5 seconds. In principle, δt can vary from a few milliseconds to much longer times such as minutes, hours, days, weeks, months or years depending on the circumstances in the individual case.

Just before the fault occurs, the autonomous switches 12 in the respective switch modules 10a . . . 10f have the following states:
switch module 10a: open
switch module 10b: closed
switch module 10c: closed
switch module 10d: closed
switch module 10e: closed
switch module 10f: open

At the time when the short circuit occurs (t=3.5 seconds), the switch module 10c detects an over current as well as switch module 10d. Timeout periods are set with respect to switch positions from the voltage sources 104, 106 to ensure that the switch of the switch module 10a . . . 10f closest to the fault (simulated by switch 130) is opened. “Timeout” means that a condition has been valid for a minimum time (time out period). As a result of the timeout delays the switch of switch module 10c is opened first, and the current has decreased before the timeout period has come to its end for the switch of the switch module 10d.

Just after the fault has occurred, the autonomous switch modules 10a . . . 10f have the following states:
switch module 10a: closed
switch module 10b: open
switch module 10c: open
switch module 10d: closed
switch module 10e: closed
switch module 10f: open

As mentioned above, results of a simulation of voltage characteristics over a time period of δt=5 seconds are shown in FIGS. 6a- 6e. FIG. 6b shows the voltage characteristic 110a of the load 110, FIG. 6c shows the voltage characteristic 112a of the load 112, and FIG. 6d shows the voltage characteristic 114a of the load 114 as the voltage 104a of voltage source 104 is constant for t>1 sec.

The voltage characteristic 130a of the fault 130 is shown in the lowest FIG. 6e. At the time t=3.5 s the short circuit occurs and the voltage 130a drops to zero. Despite this voltage break down, the voltage characteristics 110a, 112a, 114a remain on a high and virtually unchanged level because the autonomous switch modules detect the fault and react accordingly. The switch module 10a changes its state from open to closed, and the switch modules 10b and 10c change theirs states from closed to open. The other switch modules 10d . . . 10f do not change their states. By changing the states of the first three switch modules 10a, 10b, 10c, a voltage breakdown at the loads 110, 112, 114 can be avoided.

For an electrical power supply network, particularly with a ring configuration this results in an improved performance and safety of the electrical power supply. For instance, the electrical power supply network with a ring configuration can be implemented in a vehicle on-board power supply thus yielding a redundant power supply for electrical loads such as actuators, sensors, electric motors, lamps, control units etc. in the vehicle. For instance, vehicle lights such as brake lights have to fulfil special safety requirements which can be supported by such a redundant electrical power supply network as described above.

In another embodiment, the electrical power supply network with a ring configuration can be implemented in a working machine on-board power supply thus yielding a redundant power supply for electrical loads such as actuators, sensors, electric motors, lamps, control units etc. in the working machine.

In yet another embodiment, the electrical power supply network with a ring configuration can be implemented in a power supply facility thus yielding a redundant power supply for electrical loads of a multitude of user such as buildings or industrial sites. Particularly, the energy supply facility can be an emergency backup generator providing a fail-safe power supply which is active when a main power supply fails.

1. A switch module comprising at least one switch exhibiting at least two states of operation,provided for connecting at least two conductor segments of an electrical power supply network, the electrical power supply network comprising one or more power sources and one or more electrical loads, wherein one control unit is provided per switch and is operatively coupled to the switch for controlling the states of operation of the switch, wherein each control unit comprises a selection unit for selecting a state of operation of the switch coupled to the respective control unit.

2. The switch module according to claim 1 wherein the state of operation of the switch is selectable depending on one or more operating parameters of the electrical power supply network.

3. The switch module according to claim 1, wherein the control unit comprises a state machine.

4. The switch module according to claim 1, characterized by comprising at least one communication unit for communicating at least with one or more switch modules and/or a power management system.

5. The switch module according to claim 1, characterized by comprising at least one programmable unit for setting operating parameters of each switch.

6. The switch module according to claim 1, wherein at least one current sensor and/or at least one voltage sensor (16, 18) is/are coupled to each switch.

7. A method for operating a switch module according to claim 1, which switch module comprising at least one switch exhibiting two or more different states of operation and connecting at least two conductor segments of an electrical power supply network, the electrical power supply network being powered by one or more power sources and supplying one or more electrical loads wherein one control unit is provided per switch and is operatively coupled to the switch, wherein the control unit controls the states of operation of the switch, wherein the state of operation of the at least one switch is selected depending on operating parameters of the switch and/or operating parameters of the electrical power supply network.

8. The method according to claim 7, wherein the at least one switch is operated depending on an electrical current through the switch and/or an electrical voltage on both sides of the switch.

9. An electrical power supply network comprising one or more power sources and one or more electrical loads, and comprising at least one switch module according to claim 1, provided for electrically connecting and disconnecting at least two conductor segments.

10. The electrical power supply network according to claim 9, wherein at least one part of the network is configured in form of one of a star configuration of power distribution or a double star configuration of power distribution or a ring configuration of power distribution.

11. The electrical power supply network according to claim 10, characterized by a combination of different configurations of power distribution.

12. The electrical power supply network according to claim 9, characterized by that a first and a second switch module is provided for each load.

13. The electrical power supply network according to claim 9, wherein the switch module is coupled to the circuit separate from a load or that the switch module is integrated into an electric load.

14. A vehicle comprising an electrical power supply network according to claim 9.

15. A working machine comprising an electrical power supply network according to claim 9.

16. A power supply facility comprising an electrical power supply network according to claim 9.
